(19) United States
(12) Patent Application Publication
(10) Pub. No.: US 2013/0113782 A1
(43) Pub. Date: May 9, 2013

(54) Method for determining characteristics of a unique location of a selected situs and determining the position of an environmental condition at situs

(71) Applicant: Amadeus Burger, Marietta, GA (US)

(72) Inventor: Amadeus Burger, Marietta, GA (US)

(21) Appl. No.: 13/199,355

(22) Filed: Nov. 9, 2011

(51) Int. Cl. G06T 15/00

(52) U.S. Cl. 345/419

(57) ABSTRACT

The present invention includes methods for generating a 3-dimensional rendering of a subject space, and for determining the location of a desired situs therein and preferably further including dimensional positioning of an environmental condition therein, and which data may be particularly useful for use in a complex work structure, such as a nuclear power plant, an industrial plant, a mine or other complex structure.

### TECHNICAL FIELD

The present invention relates generally to a method for determining characteristics of a unique location of a selected situs and the position of a desired environmental condition at situs and, more particularly, to an improved method for determining the precise location of a selected situs, and the precise position of an environmental condition at such situs preferably within a 3-dimensional rendering in real time, which may be particularly useful in complex work structures, including but not limited to, nuclear power plants, industrial plants, mines, or other complex building structures.

### BACKGROUND

Complex work structures often have hazardous and deadly conditions, including environmental conditions, disposed within the complex work structure work space. Such hazardous conditions may include excessive temperatures, radiation, fire and other environmental hazards. As such, the presence of these environmental conditions may cause potential hazards to the workers within the workspace of the complex work structure. Thus, it is highly desirable to have the ability to locate workers and environmental conditions within a work site in real time and thereafter notify the workers of such a condition for avoidance, containment, and/or clean up. For example, extended exposure to the environmental condition of radiation to a worker can be extremely harmful making it essential to have an accurate real time method to identify, locate and target such worker and such environmental condition in order to avoid or minimize workers' exposures to a hazard.

A common obstacle in assessing potentially dangerous environmental conditions in such complex work structures, is how to accurately determine and record the precise location of a worker and/or detect and record an environmental condition that may impact a worker within the work space. The obstacles are numerous and may include recordation issues, communication issues and timing issues.

Certain prior art methods of monitoring the location of a situs and determining the position of an environmental condition at the situs are known to those of ordinary skill in the industry. However, accurate, real-time methods of locating a worker or environmental condition within a 3-dimensional rendering are not known.

In the prior art, methods of determining the location of a selected situs and the location of an environmental conditions within a situs (workspace) have typically been performed by the steps of: (1) an individual within a workspace viewing a desired situs; and (2) at some later time having the individual physically recording the location of the situs on a 2-dimensional drawing utilizing memory (at any point after the desired situs location has been viewed). Thus, in some cases, the “memorized” location is recorded instantly on a 2-dimensional drawing at the situs. In other cases the “memorized” location has is recorded at some later time resulting in memory inaccuracies. Thus, numerous problems have been associated with the aforementioned prior art methods, including user error (such as, memory problems, and recordation inaccuracies). Moreover, and due to potential user error, these prior art methods do not precisely and accurately pinpoint (i.e., within inches) the exact situs of the selected location and/or the position of a prevailing environmental condition within real time. Furthermore, when such environmental condition is detected the presence thereof may create stress and fear to the user making accurate recording by the user difficult.

Other prior art methods of determining and locating a desired situs within a work space have included (a) a user constantly carrying a large, bulky, and frequently inaccurate 2-dimensional drawing and/or chart; and (b) when a desired situs is determined, having the user physically record the desired situs on the 2-dimensional drawing/chart. Problems associated with this method may include regulatory and/or trade secret issues issues. For example, rules governing activities within the complex work structure (such as, a nuclear power plant) may not allow a user to carry drawings/charts of layout within said structure.

When built, complex work structures typically have initial architectural drawings showing the overall building layout including specific floor, equipment and room designation. Thereafter, complex work structures are frequently updated with new floor lay outs and equipment designation. Draftsman's fees to update new layout and equipment additions to the initial architectural drawings can be relatively high and thus frequently not completed. As such, drawings used in the prior art to record the location of a situs can be out of date and thus inaccurate, making it difficult and nearly impossible to determine and accurately record the precise location of a desired situs within the complex work structure. Furthermore, complex work structures are typically compartmentalized, and thus have an extensive number of rooms and equipment disposed therein, which further may be subject to frequent changes and/or additions. As such, it is difficult to reflect and display (in a 2-dimensional drawing) a current and accurate layout of a complex work structure.

Moreover, complex work structures frequently have extensive regulations and trade secret protection issues associated therewith which limit the type of equipment that can be used within the complex work structure. As stated above, complex work structures can be large with numerous rooms and equipment associated there with. As such, 2-dimensional renderings are inherently unable to show every detail in a room making it nearly impossible to accurately represent a room, floor, and overall building layout.

In prior art methods, methods of determination of characteristics of a selected situs and position of an environmental condition at situs tend to be inaccurate and not done in real time. As such, the delay and inaccuracies of determining and notifying others of the situs and the situs of environmental conditions may be harmful (and even deadly) to the user and others in the facility.

Yet other prior art methods and systems include, 3-dimensional imaging of the environmental condition itself via disposition and use of a multitude of cameras at the actual situs. For example, if radiation is detected, a multiplicity of cameras are needed at the radiation site to take a picture from all three angles to produce a 3-dimensional “image” of the radiation. However, such prior art systems are slow to record, substantially inaccurate, and are limited in their capabilities. Specifically, these prior art system fail to pinpoint the exact location of the environmental condition in real time. Furthermore, since the 3-dimensional imaging of the radiation itself requires a multiplicity of cameras or detectors, the user must carry numerous devices (i.e., cameras) and precisely set up the cameras when radiation is detected. Alternatively, each room of any potential radiation exposure site must have a multiplicity of cameras to image the radiation in 3 dimensions resulting in a substantial expense. Also, these prior art methods and systems tend to be excessively time consuming which results in unnecessary exposure to the workers in the workspace. Yet further, due to regulations and trade secret concerns certain devices are not allowed in the work space making such prior art methods impractical.

Other prior art methods to locate a situs generally include GPS technology. Unfortunately, in order to adequately contain harmful environmental conditions, such complex work structures (specifically nuclear power plants) are typically constructed from dense, signal sensitive materials (such as thick, reinforced concrete). As such, GPS technology and other exterior signal devices are not useable therewithin.

Accordingly, a simplified method where the individual worker would not have to utilize extensive equipment is thus desirable. Moreover, it would be desirable and substantially advantageous to provide an improved and accurate method for determining and measuring the unique location of a situs within a 3-dimensional environment in real time.

### SUMMARY

One object of the present invention is to provide a method to determine characteristics of a unique location of a situs by 3-dimensionally mapping a space within a complex work structure, thereafter recording the unique location of a desired situs, comparing the mapped situs with the desired situs and displaying the unique location of the desired situs in the 3-dimensional environment.

The 3-dimensional environment, known as a “mapped 3-dimensional work space”, is the best way to accurately represent and record a work space as it can represent both visual and dimensional aspects (x,y,z coordinates) of a given space.

One object of the present invention, is directed to a method for determining characteristics of a unique location of a selected situs within a space, and which method preferably includes: (1) recording the first visual indicia to define at least a portion of space; (2) transmitting the recorded first visual indicia to a database; (3) storing the recorded first visual indicia to said database; (4) mapping the first visual indicia defining said space; (5) creating within said database a 3-dimensional rendering of the space; (6) subsequently, recording a second visual indicia of the previously recorded first indicia to define a subset of space; (7) transmitting the second visual indicia to the database; (8) comparing the stored first visual indicia with the second visual indicia; and (9) matching substantially identical visual indicia of the stored first visual indicia with the second visual indicia within said database, and thus to identify a unique situs within said 3-dimensional rendering of space.

In another aspect of the present invention, the object is to determine the exact location of at least one environmental condition within a unique location of a selected situs within a pre-mapped space (also known as, 3d plant model documentation) and thereafter display the exact situs in a 3-dimensional environment precisely and in real time.

In one embodiment, the creation of a pre-mapped space (i.e., 3d plant model documentation) is preferably created via use of a scanner—however use of combination photographs and 3d CAD models are also used. 3d plant model documentation represents both visual representation and dimensional representation (x,y,z coordinates) of the space.

In another aspect of the present invention, an environmental condition may be located and recorded at a desired situs. In these embodiments, the present invention is directed to a method for determining the position of an environmental condition at a selected situs within a space, and which method preferably includes: (1) recording the first visual indicia to define at least a portion of space; (2) transmitting the recorded first visual indicia to a database; (3) storing the recorded first visual indicia to said database; (4) mapping the first visual indicia defining said space; (5) creating within said database a 3-dimensional rendering of the space; (6) detecting an environmental condition; (7) subsequently, recording a second visual indicia defining a subset of space where detection of the environmental condition occurred at the situs; (8) transmitting the portion of the subsequently recorded second visual indicia to the database with a parameter identifying the situs of the environmental condition; (9) storing the recorded second indicia and the parameter identifying the environmental condition within the database; (10) comparing the stored first visual indicia with the second visual indicia; (11) matching substantially identical visual indicia of the stored first visual indicia with the second visual indicia within said database, and thus to identify the location of the situs within said 3-dimensional rendering of space; and (12) associating the position of the situs within the 3-dimensional rendering of space with the parameter identifying the environmental condition thus to define the location of the environmental condition prevailing at the situs.

In some preferred embodiments, the preferred first step of recording first indicia to define at least a portion of the space is preferably accomplished by means of a recording device (i.e., a 3-dimensional laser scanner). The laser scanner is directly associated with mapping software of a database. Useful 3-dimensional laser scanners are known to those skilled in the art. The software (PanoMap® available from Construction System Associates, 280 Interstate North Circle, SE Suite 250, Atlanta, Ga. 30339-2409 US; http://www.csaatl.com/productspanomap.shtml) processes the data received from the 3-dimensional laser scanner to build a 3-dimensional laser scanning model (including a multiplicity of images), which is then stored within a database. The scans may then be preferably registered to a single plant coordinate system. The scan database is then preferably organized and categorized by individual aspects of the selected complex work structure (including, for example, buildings, floors, and rooms), thereby providing quick access to data regarding any part of the complex work structure. The images in the scan database/scanning model can further be identified with recognition codes, measurement indicia, and other visual indicia for future reference.

Once the complex work structure is scanned and the 3-dimensional work space is mapped and saved into a database, the next step is to record a desired location (second visual indicia) within the mapped 3-dimensional work space. The preferred method of recording the second visual indicia to define at least a portion of the space, is accomplished by a user, within the work place, taking a rendering photographically or otherwise to take a picture of a desired situs with a camera or other recording device. Thereafter, the situs data (e.g., photograph) is transmitted to the database via wireless networking or by manually plugging the recording device directly to a database hub. The mapping software then compares and matches the second visual indicia with the first indicia (previously mapped 3-dimensional work space), and thereby provides the exact situs of the desired location.

An alternative step to determine the location of a selected situs is to place bar codes or other visual indicia in selected locations within the work space (such as visual indicia on walls, floors, equipment or any other desired location). The worker within the work space would preferably use a portable recording device to record a bar code or other visual indicia within the desired location. Thereafter, the portable scanner would send the situs data to the database via a wireless network, or in the alternative the worker would manually plug the portable recording device into a database hub. The software associated with the database would instantly compare and match the situs data with the mapped 3-dimensional work space and thereby provides the exact situs of the desired location.

It is further contemplated that the worker in the workspace may carry environmental condition sensing devices such as radiation meters or others of the same ilk. When the radiation sensing device detects an undesired level of radiation, the worker can record and/or scan the exact location of the desired situs with the method described above. Other desired environmental conditioning sensing devices may include devices for sensing temperature, humidity, air pollution, carbon monoxide, fire, water, etc.

### BRIEF DESCRIPTION OF DRAWING

FIG. 1 is a chart of determining characteristics of a unique location of a selected situs within a space; and

FIG. 2 is a chart of determining the position of an environmental condition at a selected situs within a space.

### DETAILED DESCRIPTION

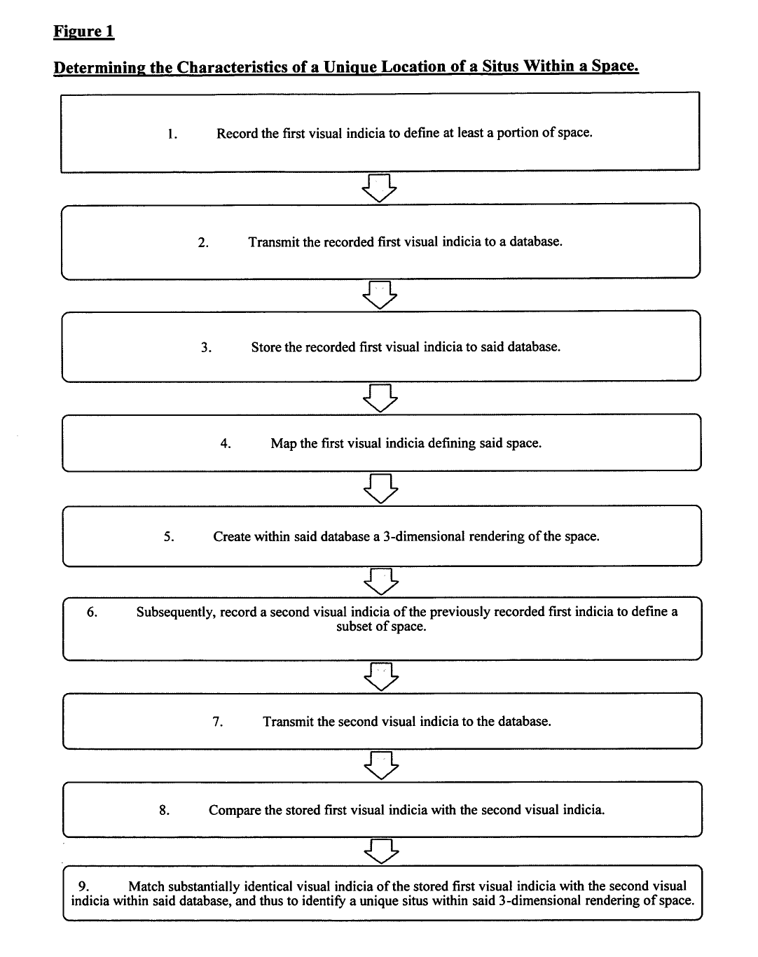

Referring to FIG. 1, in determining characteristics of a unique location of a selected situs within a space, an imaging 3-dimensional laser measurement scanner is preferably used to record the first visual indicia to define at least a portion of space. The preferred method would be to record substantially the entirety of the visual indicia to define the entirety of a space. Specifically, a scanning worker captures and records the desired portion of an as built complex work structure configuration (such as rooms, walls, floors, equipment, exits, doors or any other desired location/feature) preferably via a laser scanner. The recording device such as a laser scanner allows the user to display collected data (such as laser scan data). Such scanners are typically used in digital planning and building of complex work structures and virtual reality platforms. Scanners typically provide a 360 degree image of a desired space with detailed views of various aspects of the space (including equipment disposed therein). Furthermore, cameras and other recording devices may alternatively be used in recording the first indicia to define at least a portion of the space. The preferred laser scanner and/or recording device preferably has wireless capabilities in direct association with mapping software. The use of 3d CAD models is also contemplated.

Referring to FIG. 1, the preferred method to transmit the recorded first visual indicia to a database is preferably completed via wireless networking. However, it is contemplated that the recording device can be directly connected into the database via database hub (in a central location or a variant location). Furthermore, it is contemplated that the product of the recording device can be entered into the database via photographic scanner or similar means.

Referring to FIG. 1, the preferred method to store the recorded first visual indicia to said database is preferably completed via a laser scanner. The laser scanner collects laser scan data (preferably in the form of point-cloud data). In use, the point cloud data is converted into a small photo realistic viewing format size for easy and convenient storage. In use, the database can range in size depending on the users particular use/desires.

Referring to FIG. 1, the preferred method to map the first visual indicia defining said space, is preferably completed by taking the collected scan data and processes the collected scan data with mapping software.

Referring to FIG. 1, the preferred method to create within said database a 3-dimensional rendering of the space within the database is also completed with mapping software. The preferred software for mapping, creating, and matching visual indicia is PanoMap® (available from Construction System Associates, 280 Interstate North Circle, SE Suite 250, Atlanta, Ga. 30339-2409 US; http:www.csaat1.com/productspanomap.shtml). PanoMap® is a database driven laser scanning technology that provides accurate as built 3-dimensioanl laser scan models which captures an as built facility, such as a complex work structure, in an extremely accurate, photographic-quality 3-dimensional format. PanoMap® is typically installed onto any modern computer, with the laser scan project data remaining in the database. PanoMap® can also be installed on cellular telephones which allows real time reporting and notification of desired information to and from a worker in a given situs.

PanoMap® software uses the collected scan data received from the scanner to build a 3-dimensional laser scanning model and rendcring. The scans are processed into a visual format that is considerably smaller than any laser scan file, and organized into a laser scan database. Thereafter, the scans are registered to a single plant coordinate system. The scan database is then typically organized by desired aspects of the space/complex work structure (e.g., by buildings, floors, and rooms) in an effort to provide quick access to any part of the space/complex work structure.

The present invention may further include the step of determining and transferring a dimensional scale for preferably the first visual indicia and potentially the second visual indicia data recorded within the database thereby to accord specific measurements within said database. The determining and transferring of a dimensional scale is accomplished by the mapping software analyzing the collected data from the recording device. Thereafter, inasmuch as the 3-dimensional depiction has been thus scaled as to dimensions therewithin, the subsequent recordation of visual indicia at a selected situs will be determined, not only relatively, but also in regard to precise distances to and from each of the items within a selected space.

The collected data (images and 3-dimensional rendering) preferably resides in a single database with fast user access (for example a user can click four times in the database to access any part of a 3-dimensional rendering of a space/complex work structure). The mapping software creates database access with a friendly interface, high resolution, 3-dimensional representation. The result is an efficient database (easy access and fast processing for personnel, from a pc or hand held device). PanoMap® utilizes Plant/CMS 3-dimensional technology which allows export/import to other CAD systems used in the industry for easy interface to/from all major CAD systems.

Referring to FIG. 1, after the 3-dimensional rendering of the desired as-built space is complete, the next step to subsequently record a second visual indicia of the previously recorded first indicia to define a subset of space is preferably accomplished by a user recording a depiction with a recording device at a desired location. Preferably, the recording device is a camera having network capabilities (preferably with wireless capabilities). It is further contemplated that the user may have direct access to a central wireless hub (disposed in numerous accessible locations of the complex work structure).

It is also contemplated that the user has direct access to wireless hubs in each room of the space to ease the communication access with the database.

Referring to FIG. 1, the next step to transmit the second indicia to the database is preferably completed when the recorded second indicia data is sent wirelessly from the recording device to the database for processing and analysis. It is also contemplated that the user may manually transmit the recorded second indicia directly into the database via cable, plug or other networking device.

Referring to FIG. 1, the next step to compare the first visual indicia with the second visual indicia is preferably done with mapping software. The mapping software preferably compares and analyzes the optical geometry of the recorded second visual indicia with the first visual indicia taking into account the viewing angle and lens parameters of the recording device.

The mapping software preferably matches substantially identical visual indicia of the stored first visual indicia with the second visual indicia within said database, and thus to identify a unique situs within said 3-dimensional rendering of space. Specifically, the recorded second visual indicia is compared and matched with the stored mapped 3-dimensional work space/rendering within the database. In real time, the mapping software compares the portion of the second visual indicia with the stored defined space (i.e., first visual indicia) to indentify (e.g., and preferably within inches) the unique location of a selected situs. Once the unique situs is identified, the software displays the exact location preferably on a visual display or other visual means so the user can then utilize the information.

In other preferred and/or alternate embodiments, the step of recording a second visual indicia of the previously recorded first indicia to define a subset of space can be accomplished via scanning of pre-marked visual indicia. Specifically, the user scans pre marked visual indicia at a desired location with a hand-held scanner. Thereafter, preferably via wireless, the scanned data having pre marked visual indicia identifying the desired location is transmitted to the central database for processing, identification, and analysis. If wireless is not utilized, it is contemplated that the user can plug the scanner directly into a database hub and transmit the location therefrom. As described above, the software analyzes the recorded information (pre-marked visual indicia) and measures the exact location of the unique situs in relation to the user and thereafter displays the exact location in real time.

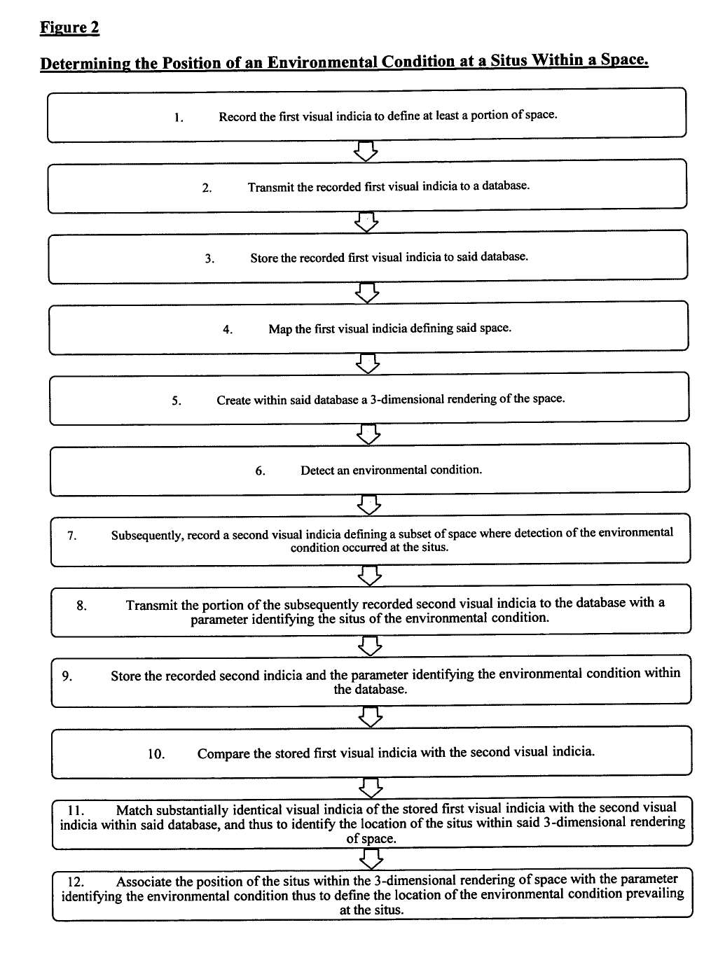

Referring to FIG. 2, the following steps are to be performed identically as to FIG. 1: (1) recording the first visual indicia to define at least a portion of space; (2) transmitting the recorded first visual indicia to a database; (3) storing the recorded first visual indicia to said database; (4) mapping the first visual indicia defining said space; and (5) creating within said database a 3-dimensional rendering of the space.

Referring to FIG. 2, the step to detect an environmental condition, a sensor is preferably used to notify the user of the presence of a desired environmental condition. In a complex work structure, the most desired environmental condition to be detected is radiation. Known radiation detection and notification systems are contemplated to detect the presence of radiation and to notify the user. In use, the user would preferably carry a radiation detector that would preferably alert a user via alarm or other notification method when the desired environmental condition (i.e., radiation) is detected.

Referring to FIG. 2, the step to subsequently record a second visual indicia defining a subset of space where detection of the environmental condition occurred at the situs is preferably completed by a user taking a picture of the location with a recording device (i.e., a camera). A environmental condition detection system is contemplated which consists of a camera and an environmental condition detection device. An alternative method to record the situs (where the environmental condition occurred), is for an environmental condition detection system to automatically take a picture of the situs when the presence of a desired environmental condition is detected. Thereafter, the environmental condition detection system would automatically send data to the central database via wireless communication. Preferably, the recorded second visual indicia would be data (i.e., photograph or parameters) showing additional information (such as equipment indicia or other visual indicia).

Referring to FIG. 2, the step to transmit the portion of the subsequently recorded second visual indicia to the database with a parameter identifying the situs of the environmental condition is preferably completed by wireless communication in connection with the recording device. Alternatively, the user can transmit the data (i.e., photograph or parameter) directly into a database hub. Other methods of transmission are contemplated. As described above, it is also contemplated for the recording device to automatically transmit the data (i.e., photograph or a parameter) when the environmental condition is detected and recorded (in real time).

Referring to FIG. 2, the step to store the recorded second indicia and the parameter identifying the environmental condition is preferably stored within a database.

Referring to FIG. 2, the step to compare the stored first visual indicia with the second visual indicia is preferably completed with the use of mapping software. The mapping software will compare the recorded (second visual indicia) with the stored data (first visual indicia). Specifically, the database software will compare the second visual indicia defining a subset of space where detection of an environmental condition occurred with the stored mapped work space (i.e., first indicia that defined at least a portion of space). The mapping software takes into account (1) the dimensional representation of the defined space (first indicia) and the recorded space (second indicia); and (2) the optical geometry of the recording device (view angle, lens aperture, and focus, etc.), of the defined space (first indicia) and the recorded space (second indicia).

Referring to FIG. 2, the step to match substantially identical visual indicia of the stored first visual indicia with the second visual indicia within said database, and thus to identify the location of the situs within said 3-dimensional rendering of space is preferably completed via mapping software as described above. The mapping software takes into account the dimensional representation of the defined space (first indicia) and the recorded space (second indicia) and the optical geometry of the recording device (view angle, lens aperture, and focus, etc.).

Referring to FIG. 2, the step to associate the position of the situs within the 3-dimensional rendering of space with the parameter identifying the environmental condition thus to define the location of the environmental condition prevailing at the situs is preferably completed with mapping software. Specifically, after the matching of the first and second indicia has occurred, within the database the mapping software associates the position of the situs within the 3-dimensional space, with a parameter identifying the environmental condition, thereby to define the location of the environmental condition prevailing at the situs. The result is a detailed precise identification of the location where the environmental condition was detected/occurred.

The precise detection of the situs is preferably displayed on a display device in a location wherein a viewer can view and determine the aforementioned location of the detected environmental condition. The result would be to notify any user(s) in the work space of the detected environmental condition and the environmental condition's location. As a result, other individuals in the work space can avoid exposure to the environmental condition. Also, a clean-up crew or environmental condition containment unit can be dispersed to the exact location to contain such environmental condition.

It is also contemplated that the exact location of any such environmental condition can be transmitted to every worker in the workspace via portable device (such as hand held devices, phones, electronic devices, etc.).

Although the invention has been described and illustrated in detail, it is to be clearly understood that the same is intended by way of illustration and example only, and is not intended to be taken by way of limitation. For example, in some implementations, the steps involving transmitting and storing on a central database can be eliminated. Specifically, the environmental condition is detected and communicated to a hand held device such as a phone with a software application and thereafter the exact situs is determined and transmitted to the central database and/or other workers having portable electronic devices such as a portable device (i.e., hand held devices, phones, electronic devices, etc.). Thus, it is recognized that numerous other variations exist, including both narrowing and broadening variations of the appended claims.

What is claimed is:

1. . A method for determining characteristics of a unique location of a selected situs within a space, said method comprising:
recording first indicia to define at least a portion of the space;
transmitting the recorded first indicia to a database;
storing the recorded first indicia within said database;
mapping the first indicia defining said space;
creating within said database a 3-dimensional rendering of the space;
subsequently, at the selected situs recording second indicia defining a subset of said space;
transmitting the second indicia to the database;
comparing said first and second indicia; and
finding matching first and second indicia, and thus to identify the location of the situs within said 3-dimensional rendering of the space.

2. The method for determining characteristics of a unique location of a selected situs within a 3-dimensional space of claim 1, wherein said first indicia comprises visual indicia.

3. The method for determining characteristics of a unique location of a selected situs within a 3-dimensional space of claim 1, wherein said second indicia comprises visual indicia.

4. The method for determining characteristics of a unique location of a selected situ within a 3-dimensional space of claim 1, wherein said recording first indicia to define at least a portion of the space is accomplished by means selected from the group consisting of laser scanning, digital imaging, photographing, and CAD modeling.

5. The method for determining characteristics of a unique location of a selected situs within a 3-dimensional space of claim 1, wherein said mapping of the first indicia defining said space to create within said database a 3-dimensional rendering of the space is selected from the group consisting of visual representations and dimensional representations of the space and combinations thereof.

6. The method for determining characteristics of a unique location of a selected situs within a 3-dimensional space of claim 1, wherein the space is a complex structure.

7. The method for determining characteristics of a unique location of a selected situs within a 3-dimensional space of claim 1, wherein the complex structure selected from the group consisting of a nuclear plant, an industrial plant, a mine, and a building.

8. The method for determining characteristics of a unique location of a selected situs within a 3-dimensional space of claim 1, wherein the situs is occupied by an object.

9. The method for determining characteristics of a unique location of a selected situs within a 3-dimensional space of claim 8, wherein the object is selected from the group consisting of a person, equipment and a device.

10. The method for determining characteristics of a unique location of a selected situs within a 3-dimensional space of claim 8, wherein the object is selected from the group consisting of a stationary object and a moving object.

11. The method for determining characteristics of a unique location of a selected situs within a 3-dimensional space of claim 1, wherein the matching of the first and second indicia for identifying the location of the selected situs within said 3-dimensional rendering of the space is determined from analysis of the optical geometry at the selected situs.

12. The method for determining characteristics of a unique location of a selected situs within a 3-dimensional space of claim 11, wherein the recording of second indicia defining a subset of said space is made photographically, and the matching of the first and second indicia for identifying the location of the selected situs within said 3-dimensional rendering of the space determined from analysis of the optical geometry at the selected situs is calculated through utilization of viewing angle and lens parameters.

13. The method for determining characteristics of a unique location of a selected situs within a 3-dimensional space of claim 1, further comprising the step of pre-marking detectable indicia upon an object at the selected situs.

14. The method for determining characteristics of a unique location of a selected situs within a 3-dimensional space of claim 1, further comprising the step of determining and transferring thereto a dimensional scale for the visual indicia data recorded within the database, thereby to accord specific measurements to the visual indicia stored within said database.

15. The method for determining characteristics of a unique location of a selected situs within a 3-dimensional space of claim 14, wherein the dimensional scale is integrated upon the 3-dimensional rendering of the data.

16. The method for determining characteristics of a unique location of a selected situs within a 3-dimensional space of claim 1, wherein said recording of first indicia comprises recording substantially the entirety of the indicia defining said space.

17. A method for determining characteristics of a unique location of a selected situs within a space, said method comprising:
recording first indicia to define at least a portion of the space;
transmitting the first indicia to a database;
storing the recorded first indicia within said database;
mapping the recorded first indicia defining said space;
creating within said database a 3-dimensional rendering of the space;
detecting an environmental condition;
subsequently, at the selected situs recording second indicia defining a subset of said space where detection of the environmental condition occurred;
transmitting the portion of the subsequently recorded second indicia to the database with a parameter identifying the situs of the environmental condition;
storing the recorded second indicia and the parameter identifying the environmental condition within the database;
comparing the first indicia and the second indicia;
matching first indicia and the second indicia, and thus to identify the location of the situs within said 3-dimensional rendering of the space; and
associating the position of the situs within the 3-dimensional rendering of the space with the parameter identifying the environmental condition, thereby to define the location of the environmental condition prevailing at the situs.

18. The method for determining characteristics of a unique location of a selected situs within a 3-dimensional space of claim 17, further comprising the step of storing within the computer the parameter identifying the environmental condition.

19. The method for determining characteristics of a unique location of a selected situs within a 3-dimensional space of claim 17 wherein the environmental condition comprises radiation.

20. The method for determining characteristics of a unique location of a selected situs within a 3-dimensional space of claim 17, further comprising the step of measuring the amount of the environmental condition.
